(19) United States
(12) Patent Application Publication
(10) Pub. No.: US 2007/0058742 A1
(43) Pub. Date: Mar. 15, 2007

(54) Distributed antenna system using signal precursors

(76) Inventors: Anthony Demarco, Newport Beach, CA (US); Matthew J. Hunton, Liberty Lake, WA (US); Alexander Rabinovich, Cypress, CA (US)

Correspondence Address: David L. Henty;Myers Dawes Andras & Sherman LLP, Suite 1150, 19900 MacArthur Boulevard, Irvine, CA, 92612, US

(21) Appl. No.: 11/518,112

(22) Filed: Sep. 7, 2006

Related U.S. Application Data
(60) Provisional application No. 60/715,889, filed on Sep. 9, 2005.

(51) Int. Cl. H04K 1/10

(52) U.S. Cl. 375/260

(57) ABSTRACT

A system and method for distributing multiple wireless carriers to transmission sites is disclosed. Carrier precursors are distributed which are digital in format and compressed in bandwidth. The individual carrier precursors are combined using time division multiplexing to eliminate the need for excess bandwidth allotments. A separate time division multiplexed control channel is created to communicate carrier configuration and operating status information. With the carrier precursor data and configuration information, a software-defined radio is used to create actual carriers at or near the transmission location. Creating carriers at or near the transmission location provides the additional benefit of reducing transmission losses between the transmit antenna and the signal generating radio.

### RELATED APPLICATION INFORMATION

This application claims the benefit under 35 U.S.C. 119 (e) of U.S. provisional patent application Ser. No. 60/715,889, filed on Sep. 9, 2005, incorporated herein by reference in its entirety.

### FIELD OF THE INVENTION

The present invention relates to wireless communications systems and related methods.

### BACKGROUND, PRIOR ART AND RELATED INFORMATION

Modern wireless communication systems convert all information into a digital data format. This data is then encoded for security and error correction purposes. The resulting data is then converted into transmission symbols. Each symbol represents one or more encoded bits of information. The symbol pattern selected permits higher transmission data rates, eases transmitter requirements, eases receiver requirements, or provides some or all of these benefits. In some systems, symbols are then spread using orthogonal codes permitting several symbol channels to be combined on one carrier without interference. This spreading process creates a multiple number of symbols (or chips) for each pre-spread symbol. Spread symbols (or chips) can then be combined into one complex data stream. Symbols (or combined chips) are then digitally converted into a band limited baseband signal through filtering. Finally the band limited baseband signal is converted into an analog signal for amplification and transmission. A similar process occurs in signal reception but with the steps reversed.

Even with the above-mentioned modem techniques, data transmission rates are limited on a per carrier basis. When higher data transmission rates are needed, multiple carriers are used. Each carrier is allotted a fixed bandwidth. These fixed bandwidths are referred to as carrier assignments. The bandwidth of each carrier assignment is larger than the actual carrier bandwidth. Larger bandwidths are allotted to reduce adjacent channel interference during reception. In frequency division duplex systems (FDD) companion receive carrier assignments are allocated in a receive frequency band for each transmit carrier. When carrier assignments are discussed in FDD systems, both transmit and receive frequencies are implied.

In some cases, wireless service providers are assigned carrier assignments in non-adjacent frequencies. Wireless service providers also operate in several different frequency bands (cellular, PCS, etc.) and using more than one transmission format (GSM, WCDMA, etc.). In some cases, wireless service providers lease signal distribution and transmission equipment from a third party. Such third parties are known as neutral host service providers. Neutral host service providers, use common equipment shared by several independent wireless service providers, each operating in different frequency bands, each using multiple carriers, and each using different transmission formats. Wireless service providers, whether independent or neutral host, require an efficient means of distributing multiple carrier, multiple format wireless carriers to transmission sites.

Accordingly a need presently exists for a more efficient system and method for distributing multiple carrier, multiple format wireless carriers to transmission sites.

### SUMMARY OF THE INVENTION

The present invention provides a system and method for distributing multiple wireless carriers to transmission sites.

In one aspect, the present invention provides a method of communication of wireless transmission signals to remotely located transmit locations by generating a plurality of digital carrier precursor symbols corresponding to multiple RF carriers, producing a combined multi-carrier RF signal from the plurality of carrier precursor symbols, then reproducing the precursor symbols of each of the carrier signals from the combined multi-carrier RF signal employing an RF-to-data conversion to extract the original digital carrier precursor symbols. The reproduced digital carrier precursor symbols are then sent to one or more remote transmit locations.

In accordance with one preferred embodiment of the present invention, generating a combined multi-carrier RF signal comprises generating a plurality of RF carrier signals from separate digital carrier precursor symbols and combining the plurality of RF carrier signals to generate the combined multi-carrier RF signal. Alternatively, generating a combined multi-carrier RF signal may comprise combining the plurality of digital carrier precursor symbols to generate a combined multi-carrier digital signal and converting the combined multi-carrier digital signal into a combined multi-carrier RF signal.

Sending the reproduced digital carrier precursor symbols to one or more remote transmit locations can comprise sending the digital carrier precursor symbols over a data network. Each of the remote transmit locations can comprise a software defined radio and one or more antennas coupled thereto.

In accordance with further features of the present invention, reproducing the precursor symbols of each of the carrier signals from the combined multi-carrier RF signal preferably comprises sampling the combined multi-carrier RF signal at a first RF sample rate to provide a digital signal at the first RF sample rate, converting the RF sample rate digital signal into a plurality of separate digital carrier signals, and extracting the original digital precursor symbols from each digital carrier signal at a lower symbol sample rate.

Converting the RF sample rate digital signal into a plurality of separate digital carrier signals preferably comprises splitting the RF sample rate digital signal into a plurality of digital signal processing paths and isolating one receive carrier on each digital signal processing path through frequency translation. Reproducing the precursor symbols of each of the carrier signals from the combined multi-carrier RF signal may further comprise providing a filtering operation on each digital signal processing path. The method may further comprise receiving transmit control information and employing the transmit control information to control one or more of the operations of frequency translation, filtering and extracting the original digital precursor symbols from each digital carrier signal at a lower symbol sample rate.

In accordance with a further feature of the present invention, the communication method further includes the steps of receiving digital carrier precursor symbols from the remote transmit locations, generating a plurality of carrier signals from the carrier precursor symbols, and combining the plurality of carrier signals to generate a combined multi-carrier RF signal.

In another aspect, the present invention provides a wireless communication system for wireless transmission of signals to remotely located transmit locations. The system comprises a transmit base station that generates a combined multi-carrier RF signal from a plurality of digital carrier precursor symbols corresponding to multiple RF carriers, and a precursor reproducer that reproduces the precursor symbols of each of the carrier signals from the combined multi-carrier RF signal, for transmission to one or more remote transmit locations.

In one example, the base station comprises a plurality of parallel signal generation paths that generate the plurality of RF carrier signals from separate digital carrier precursor symbols, a combiner that combines the plurality of RF carrier signals to generate said combined multi-carrier RF signal, and a data-to-RF converter that converts the combined multi-carrier digital signal into a combined multi-carrier RF signal. Further, each of said remote transmit locations can comprise a software defined radio and one or more antennas coupled thereto.

In accordance with further features of the present invention, the precursor reproducer comprises a sampler that samples the combined multi-carrier RF signal at a first RF sample rate to provide a digital signal at the first RF sample rate, a converter that splits the RF sample rate digital signal into a plurality of separate digital carrier signals, and a symbol extractor that extracts the original digital precursor symbols from each digital carrier signal by sampling each digital carrier signal at a lower symbol sample rate than the first RF sample rate. In one example, the converter comprises a splitter that splits the RF sample rate digital signal into a plurality of digital signals, and a plurality of digital signal processing paths that receive that plurality of digital signals, wherein each digital signal processing path comprises a frequency translator that isolates one receive carrier signal from the respective digital signal. Each digital signal processing path may further comprise a baseband filter that provides a filtering operation on the receive carrier signal isolated by the corresponding frequency translator.

In accordance with further features of the present invention, the communication system further comprises a control data link for receiving transmit control information. The control information is employed for controlling one or more of: the carrier signal isolation function of at least one of the frequency translators, the filtering operation of at least one of the baseband filters, and operation of at least one of the symbol extractors in extracting the original digital precursor symbols from each digital carrier signal at said lower symbol sample rate.

In another aspect, the present invention provides a wireless communication system, comprising a base station that generates a combined multi-carrier RF signal from a plurality of digital carrier precursor symbols corresponding to multiple RF carriers, a precursor reproducer that reproduces the precursor symbols of each of the carrier signals from the combined multi-carrier RF signal for transmission to one or more remote transmit locations, and a multiplexer that receives digital carrier precursor symbols from the one or more remote transmit locations and generates a combined multi-carrier RF signal from the carrier precursor symbols for transmission to the base station.

Preferably, the multiplexer comprises a plurality of digital signal processing paths that receive separate digital carrier precursor symbols, wherein each digital signal processing path generates a carrier signal from corresponding digital carrier precursor symbols, and a combiner that combines the plurality of carrier signals to generate said combined multi-carrier RF signal, for transmission to the base station.

In accordance with further features of the present invention, the wireless communication system may comprise multiple base stations, wherein each base station generates a combined multi-carrier RF signal from a plurality of digital carrier precursor symbols corresponding to multiple RF carriers. The system may then further include multiple precursor reproducers, wherein each precursor reproducer reproduces the precursor symbols of each of the carrier signals from a corresponding combined multi-carrier RF signal, for transmission to one or more remote transmit locations, and multiple multiplexers that receive separate digital carrier precursor symbols from one or more remote transmit locations, wherein each multiplexer generates a combined multi-carrier RF signal from corresponding carrier precursor symbols.

Further features and advantages will be appreciated from the following detailed description of the invention.

### BRIEF DESCRIPTION OF THE DRAWINGS

FIG. 1 shows a base station (BTS) transmit (TX) radio suite forming part of the distributed antenna system in a preferred embodiment of the present invention. The TX radio suite shown uses conventional individual RF carrier generation and RF combining.

FIG. 2 shows a base station (BTS) receive (RX) radio suite forming part of the distributed antenna system in a preferred embodiment of the present invention. The RX radio suite shown uses conventional RF dividing and individual carrier reception.

FIG. 3 shows a base station (BTS) transmit (TX) radio suite which may also form part of the distributed antenna system in a preferred embodiment of the present invention. The TX radio suite shown produces a multiple carrier signal digitally and then converts that digital signal to RF for transmission.

FIG. 4 shows a base station (BTS) receive (RX) radio suite which may also form part of the distributed antenna system in a preferred embodiment of the present invention. The RX radio suite shown converts a broad band RF signal path into one digital signal and then provides several independent receive digital signal processing paths.

FIG. 5 shows a preferred embodiment of a TX RF to precursor de-multiplexer module in accordance with one aspect of the present invention. This module forms part of the distributed antenna system in a preferred embodiment of the present invention and recreates transmit carrier path digital signal precursors and TX control information from the combined transmit RF signal.

FIG. 6 shows a preferred embodiment of a RX precursor to RX RF signal multiplexer (600) in accordance with another aspect of the present invention. This circuit forms part of the distributed antenna system in a preferred embodiment of the present invention and creates a broadband receive signal from received digital signal digital precursors.

FIG. 7 shows a base station (BTS) transmit and receive multiple carrier symbol multiplexing combiner forming part of the distributed antenna system in a preferred embodiment of the present invention.

FIG. 8 shows a preferred embodiment of a multiple carrier precursor de-multiplexer (800) in accordance with another aspect of the present invention. This circuit forms part of the distributed antenna system in a preferred embodiment of the present invention and de-multiplexes multiple carrier symbols that were previously combined in a symbol multiplexing combiner (FIG. 7). After de-multiplexing carrier symbols may be further processed into more primitive carrier precursors. (E.g., data channel symbols may be created from spread spectrum chips.)

FIG. 9 shows one embodiment of an overall distributed antenna system in accordance with the present invention where several base stations (BTS), located in a base station (BTS) hotel, are combined through signal conditioning to produce a multiple format network link constructed from carrier precursors which connect software defined radios to the BTS hotel using standard data network methods. The multiple format network link includes control information for proper carrier regeneration and equipment status communication.

FIG. 10 shows an embodiment of a system network architecture employing a standard data link hub connection between a base station (BTS) hotel, shown in FIG. 9, and several software defined radios.

FIG. 11 shows an embodiment of a system network architecture employing a standard data link ring connection between a base station (BTS) hotel, shown in FIG. 9, and several software defined radios.

FIG. 12 shows an embodiment of a system network architecture employing a standard data link daisy chain connection between a base station (BTS) hotel, shown in FIG. 9, and several software defined radios.

### DETAILED DESCRIPTION OF THE INVENTION

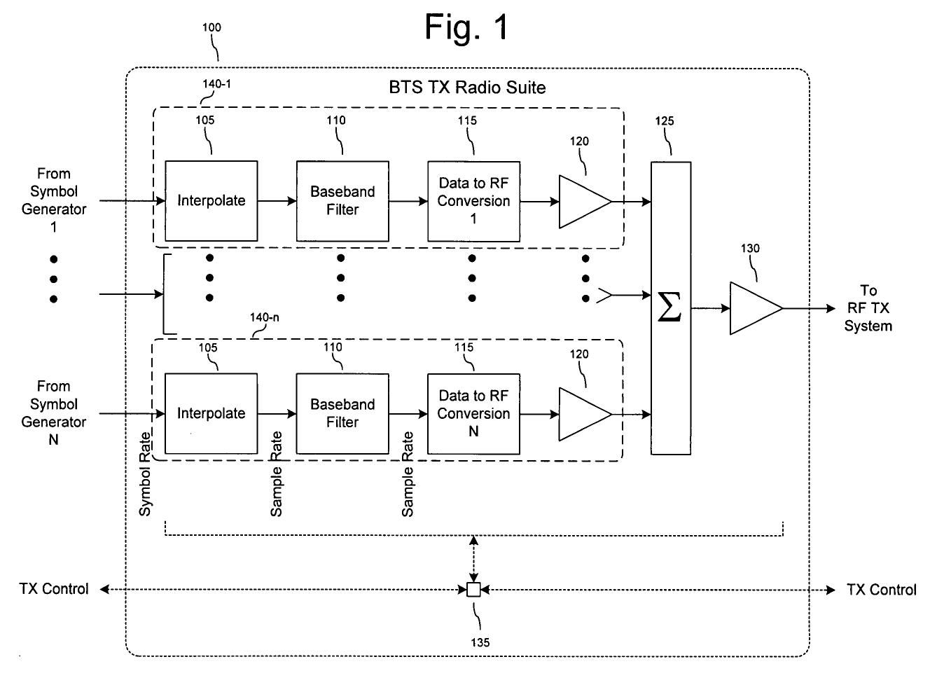

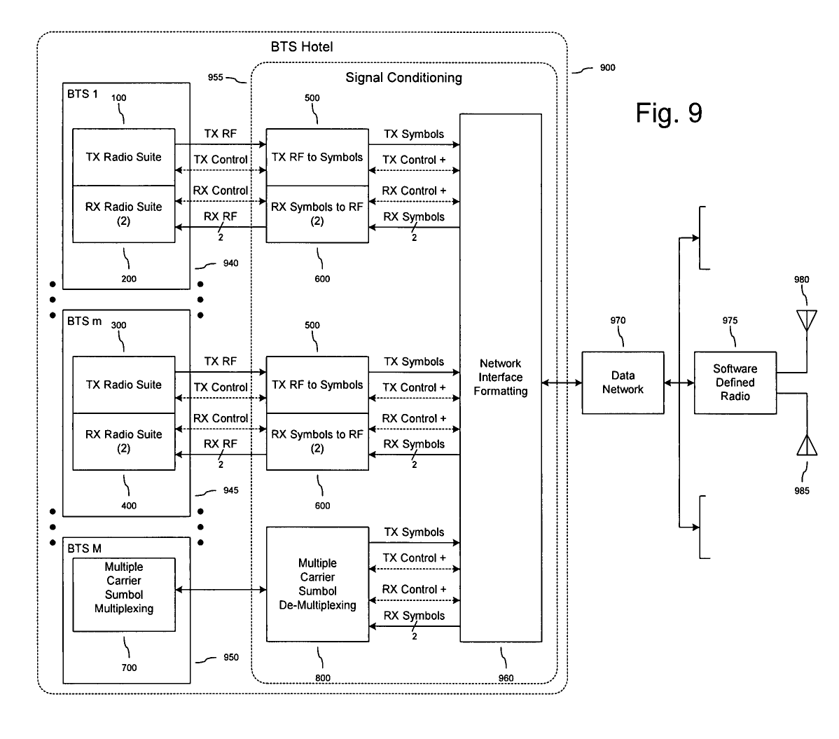

FIG. 1 shows a base station (BTS) transmit (TX) radio suite (100) forming part of the distributed antenna system of the present invention (as illustrated in FIG. 9 discussed below). FIG. 1 shows a plurality of parallel signal generation paths (140-1 to 140-n) which may be conventional in nature. The input of each path comes from a symbol generator (not shown). Symbol generators accept digital data bits, ones and zeros, and convert them into complex symbols. Each parallel path of FIG. 1 has a unique source of data bits. Each symbol generated can represent one or more data bits. These symbols are generally gain weighted prior to entering FIG. 1. The symbol generator, along with the baseband filter (110), determine the modulation format used in each parallel radio path. Each radio path may use an identical symbol generator, such as GMSK, QPSK, 8-PSK, 16-QAM, etc. and identical baseband filters, as implied by the FIG. 1, or each path may use different symbol generators and baseband filters. Each path includes an interpolation circuit (105). Interpolation circuit (105) converts the data symbol rate into a signal sample rate by inserting zeros between the data symbols. The signal is then baseband filtered (110) to limit the signal bandwidth. Those skilled in the art will appreciate that interpolation (105) and baseband filtering (110) can be combined into one function known as a poly-phase filter (not shown). After bandwidth limiting, the baseband signal is converted to an RF signal (115). Several methods can be used for baseband digital signal conversion to radio frequency (RF), as known to those skilled in the art. Each data to RF conversion block (115) crates a carrier output at a unique frequency. Each carrier is then optionally gain adjusted (120) and combined (125) to produce a common RF output. The signal combination (125) may be accomplished by hybrid combiners, filter combiners, or other methods known to those skilled in the art. This combined output may then be optionally gain adjusted and output to the BTS RF TX system.

FIG. 1 also shows a TX control data link for the BTS TX radio suite. This control information may change, for each path, the interpolation rate (105), characteristics of the baseband filter (110), frequency of the data to RF conversion (115), gain of the individual paths (120), frequency of a elements of a frequency selective combiner (125), or adjust the common gain (130). The control data path is shown as bidirectional. Status information from the constituent parts of the BTS TX radio suite (100) can be communicated over this base station control link. The control link shows a data hub (135). This data hub permits control and equipment status information to and from subsequent elements of the RF TX path to be communicated over the TX Control data link.

The TX control link can be constructed using various methods known to those skilled in the art.

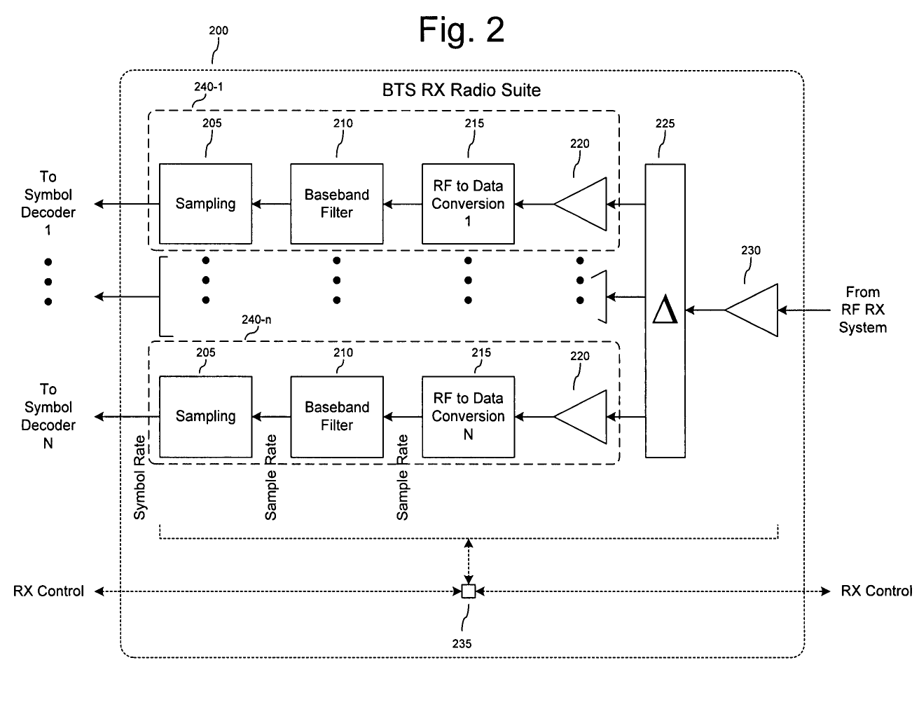

FIG. 2 shows a base station (BTS) transmit (RX) radio suite (200) forming part of the distributed antenna system of the present invention (as illustrated in FIG. 9 discussed below). FIG. 2 shows a plurality of parallel signal reception paths (240-1 to 240-n) which may be conventional in nature. The input to the BTS RX radio suite (200) is the RF RX system. In a basic BTS this RF RX system input would be connected to a suitable antenna system. The RF input is then optionally amplified (220), typically with a low noise amplifier (LNA). The input signal is then divided into several RF paths (225). This division may use hybrid dividers, frequency multiplexers or other methods known to those skilled in the art. Each RF path generally will include additional amplification (220). Each path is then converter from and RF to a digital signal (215). Each conversion (215) is frequency selective isolating one received RF carrier. This RF carrier is then received and baseband filtered (210) for optional demodulation and post processing. The signal is then sampled (205) reducing the received data rate to the receive signal symbol rate. Received symbols are then sent to a suitable symbol decoder to retrieve received data.

FIG. 2 also shows a RX control data link for the BTS RX radio suite. This control information may change, for each path, the sampling rate (205), characteristics of the baseband filter (210), frequency selection (215), gain of the individual paths (220), or the common gain (230). The control data path is show as bi-directional. Status information from the constituent parts of the BTS RX radio suite (200) can be communicated over this base station control link. The control link shows a data hub (235). This data hub permits control and equipment status information to and from subsequent elements of the RF RX path to be communicated over the RX control data link. The RX control link can be constructed using various methods known to those skilled in the art.

FIG. 1 and FIG. 2 constitute an exemplary set of TX and RX radios within a BTS. For descriptive convenience, common TX and RX elements have been respectively bundled based on function. In actual systems, the TX and RX path of a communication link will generally exist within the same physical unit. Several TX/RX radio systems will then be used to create a multiple channel BTS. The correlation between such actual systems and the system represented by FIG. 1 and FIG. 2 are well understood by those skilled in the art. Additionally, the TX and RX control links are often shared within each physical TX/RX radio. The correlation between such actual control systems and the system represented by FIG. 1 and FIG. 2 are well understood by those skilled in the art.

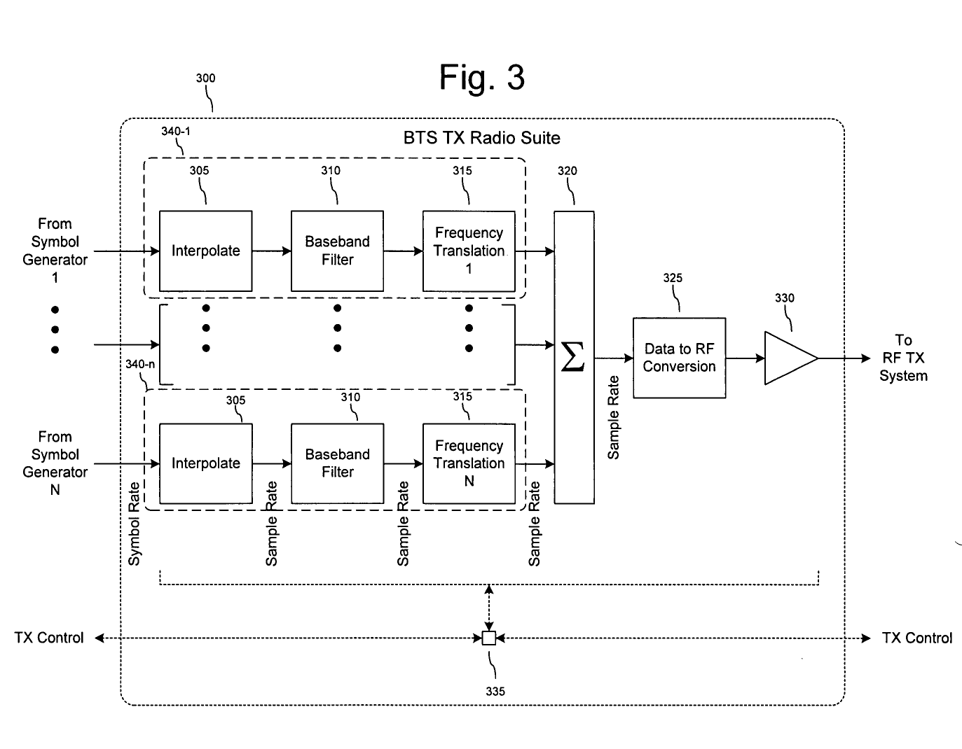

FIG. 3 shows a base station (BTS) transmit (TX) radio suite (300) which may also form part of the distributed antenna system of the present invention (as illustrated in FIG. 9 discussed below). FIG. 3 shows a plurality of parallel signal generation paths (340-1 to 340-n) which may be conventional in nature. The input of each path comes from a symbol generator (not shown). Symbol generators accept digital data bits, ones and zeros, and convert them into complex symbols. Each parallel path 340-1 to 340-n of FIG. 3 has a unique source of data bits. Each symbol generated can represent one or more data bits.

These symbols are generally gain weighted prior to entering Interpolator (305). The symbol generator, along with the baseband filter (310), determine the modulation format used in each parallel radio path. Each radio path may use an identical symbol generator, such as GMSK, QPSK, 8-PSK, 16-QAM, etc. and identical baseband filters, as implied by the FIG. 3, or each path may use different symbol generators and baseband filters. Each path includes interpolation circuit (305). Interpolation circuit (305) converts the data symbol rate into a signal sample rate by inserting zeros between the data symbols. The signal is then baseband filtered (310) to limit the signal bandwidth. Those skilled in the art will appreciate that interpolation (305) and baseband filtering (310) can be combined into one function known as a poly-phase filter (not shown). After bandwidth limiting, the baseband signal is offset in frequency (315). Each path is offset to a unique frequency. The frequency translation element (315) may also independently adjust the gain of the carrier path. Each carrier path is then combined (320) to produce a common digital signal. The common digital signal is then converted to an RF signal. Several methods exist to convert the digital signal to an RF signal. These methods are know to those skilled in the art. This combined RF output signal may then be optionally gain adjusted and output to the BTS RF TX system.

FIG. 3 also shows a TX control data link for the BTS TX radio suite. This control information may change, for each path, the interpolation rate (305), characteristics of the baseband filter (310), frequency offset (315), gain of the individual paths (315), or adjust the common gain (330). The control data path is shown as bidirectional. Status information from the constituent parts of the BTS TX radio suite (300) can be communicated over this base station control link. The control link shows a data hub (335). This data hub permits control and equipment status information to and from subsequent elements of the RF TX path to be communicated over the TX Control data link. The TX control link can be constructed using various methods known to those skilled in the art.

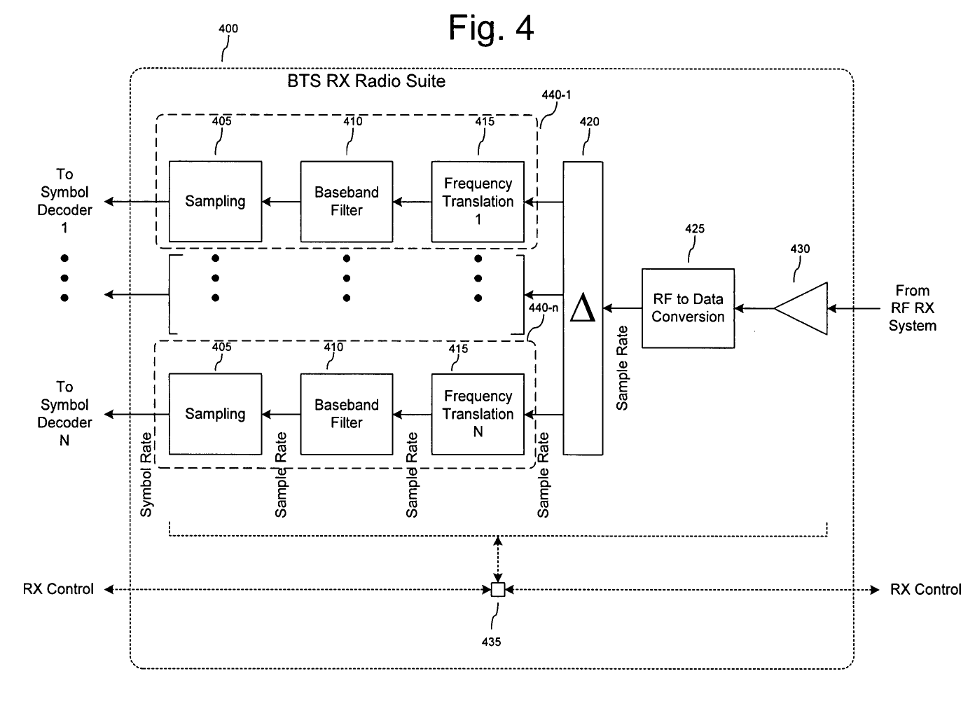

FIG. 4 shows a base station (BTS) transmit (RX) radio suite (400) which may also form part of the distributed antenna system of the present invention (as illustrated in FIG. 9 discussed below). FIG. 4 shows a plurality (1 . . . n) of parallel signal reception paths (440-1 to 440-n) which may be conventional in nature. The input to the BTS RX radio suite (400) is the RF RX system (not shown). In a basic BTS this RF RX system input would be connected to a suitable antenna system. The RF input is then optionally amplified (430), typically with a low noise amplifier (LNA). The input signal is then converted from an RF signal to a digital signal (425). Several methods exist for RF to digital signal conversion. These methods are well known to those skilled in the art. The common RX digital signal is then divided (420) in to several digital signal processing paths (405). Each path isolates one receive carrier through frequency translation (415). This carrier is then baseband filtered (410) for optional receive demodulation. The baseband filtered signal is then sampled (405) reducing the received data rate to the receive signal symbol rate. Received symbols are then sent to a symbol decoder to retrieve transmitted data.

FIG. 4 also shows a RX control data link for the BTS RX radio suite. This control information may change, for each path, the sampling rate (405), characteristics of the baseband filter (410), frequency translation (415), gain of the individual paths (415), or the common gain (430). The control data path is show as bidirectional. Status information from the constituent parts of the BTS RX radio suite (400) can be communicated over this base station control link. The control link shows a data hub (435). This data hub permits control and equipment status information to and from subsequent elements of the RF RX path to be communicated over the RX Control data link. The RX control link can be constructed using various methods known to those skilled in the art.

FIG. 3 and FIG. 4 constitute a plural carrier digital radio. For descriptive convenience, common TX and RX elements have been described separately. In actual systems, these TX and RX suites will generally exist within the same physical unit. Additionally, the TX and RX control links are often shared within each physical multiple carrier digital TX/RX radio.

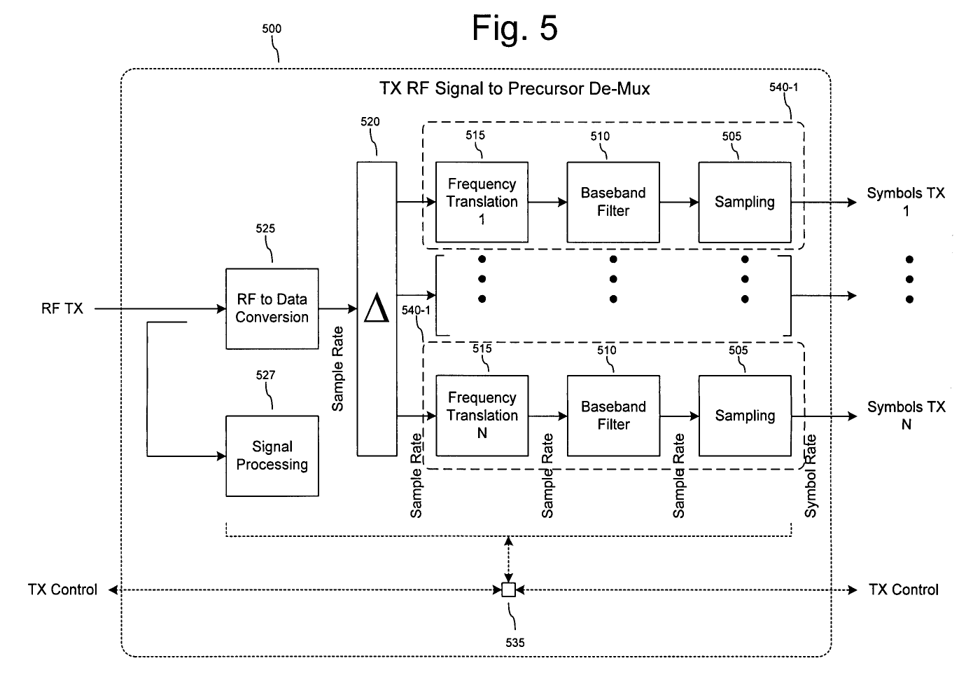

FIG. 5 shows a preferred embodiment of a TX RF to precursor de-multiplexer (500) module in accordance with one aspect of the present invention. De-multiplexer (500) module forms part of the distributed antenna system of the present invention (as illustrated in FIG. 9 discussed below). The input to de-multiplexer (500) module is the RF TX BTS system output. This would be the “to RF TX System” output of either FIG. 1 or FIG. 3. The de-multiplexer (500) module of FIG. 5 effectively provides an inverse function to that of FIG. 1 or FIG. 3 by producing the precursors of each carrier via the parallel paths (540-1 to 540-n). The carrier precursors produced by FIG. 5 are a regeneration the original carrier precursors (symbols) input to FIG. 1 or FIG. 3. The description of FIG. 5 is essentially identical to that of FIG. 4 with 500 series identifiers replacing 400 series identifiers, with the direction of signal flow now moving from left to right, and with TX replacing RX. Similarly, FIG. 5 could be replaced with an embodiment represented by FIG. 2 (reversed in a manner similar to the FIG. 4 reversal) where each RF carrier is individually converted from RF to data just after RF signal dividing.

For spread spectrum systems, FIG. 5 could be extended. In a spread spectrum system, the “Symbol TX” outputs would represent chip data. This chip data could be divided and de-spread to re-constitute channel symbol data to each spread spectrum user. The dividing and de-spreading steps following sampling (505) in FIG. 5 are not shown but should be well understood by those skilled in the art.

FIG. 5 includes a TX control link. This link is bi-directional. TX control data from the BTS will affect the TX RF to carrier precursor de-multiplexer. Control information will determine the frequency translation of each signal path, set the baseband filter coefficients, adjust the sampling rate, and adjust path gain (not shown). The TX RF to carrier precursor de-multiplexer (500) also includes a data link hub (535). This data hub permits control and equipment status information to and from subsequent elements of the RF TX path to be communicated over the RX control data link. The data link hub includes communication conditioning functions. These functions match communication protocols and circuits to the intended communication destination. The RX control link can be constructed using various methods known to those skilled in the art.

FIG. 5 also includes a signal processing block (527). This block analyzes the RF signal input from the BTS. In many BTS systems the control information over the “TX Control” line may be very limited or even nonexistent. This means that control information such as carrier frequency, TX power level, etc. must be determined by analyzing the RF TX input. Information gain from this signal analysis will then be communicated to other elements of the present invention using the data link hub (535) and the TX control link.

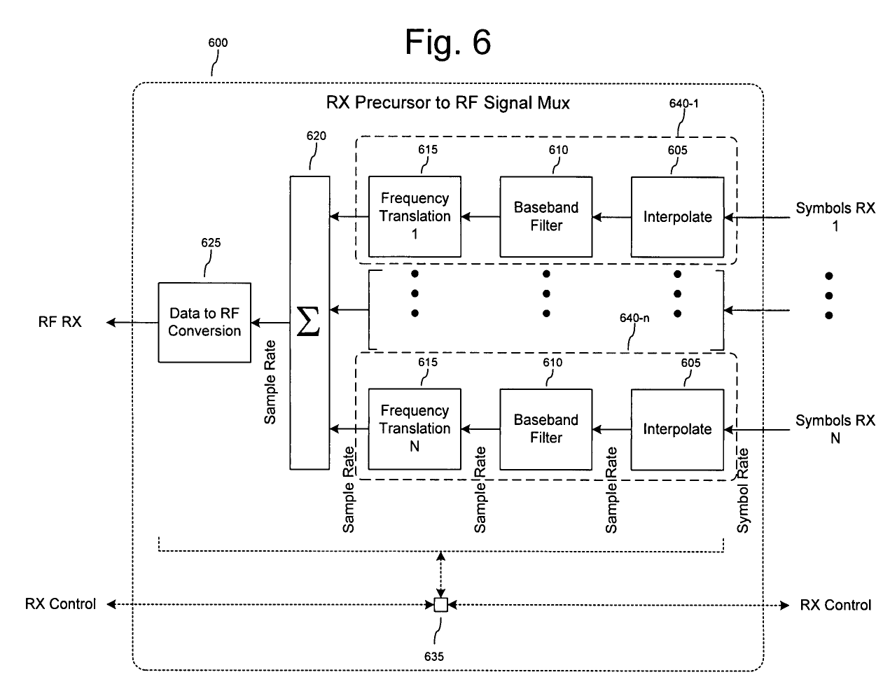

FIG. 6 shows a preferred embodiment of a RX precursor to RX RF signal multiplexer (600) in accordance with another aspect of the present invention. RX RF signal multiplexer (600) forms part of the distributed antenna system of the present invention (as illustrated in FIG. 9 discussed below). FIG. 6 includes a plurality of parallel paths (640-1 to 640-n). Each path has as an input RX carrier precursor data. The source of this precursor data is yet to be described. FIG. 6 acts effectively as an inverse function to FIG. 4 and FIG. 2. FIG. 6 produces a broadband multiple carrier RX signal from individual carrier RX precursors. FIG. 4 and FIG. 2 produce individual carrier RX precursors from a broadband multiple carrier RX signal. The description of FIG. 6 is essentially identical to that of FIG. 3 with 600 series reference numerals replacing 300 series reference numerals, with the direction of signal flow now moving from right to left, and with RX replacing TX. Similarly, FIG. 6 could be replaced with an embodiment represented by FIG. 1 (reversed in a manner similar to the FIG. 3 reversal) where each RX RF carrier is individually converted from data just prior to RF combining.

For spread spectrum systems, FIG. 6 could be extended. In a spread spectrum system the “Symbol RX” inputs would represent chip data. This chip data could be created from pre-spread user channel symbol data. Steps for user channel symbol spreading and user channel chip data combination could come before the interpolate (605) function of FIG. 6.

FIG. 6 includes a RX control link. This link is bidirectional. RX control data from the BTS will effect the RX precursor data to RF RX multiplexer. Control information will determine the frequency translation of each signal path, set the baseband filter coefficients, adjust the interpolation rate, and adjust path gain (not shown). The RX precursor data to RF RX multiplexer (600) also includes a data link hub (635). This data hub permits control and equipment status information to and from external elements of the RF RX path to be communicated over the RX Control data link. The data link hub includes communication conditioning functions. These functions match communication protocols and circuits to the intended communication destination. The RX control link can be constructed using various methods known to those skilled in the art.

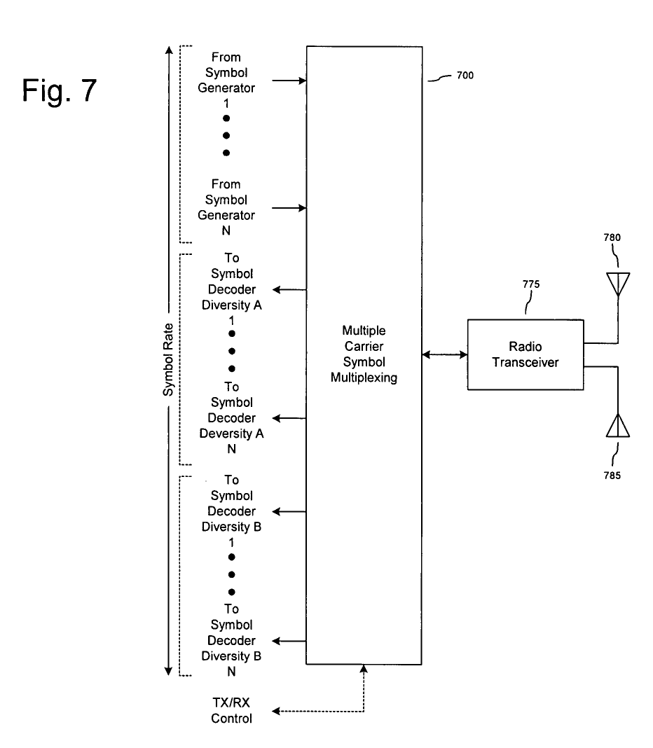

FIG. 7 shows a system for linking TX/RX carrier symbols with a digital radio transceiver (775) which may also form part of the distributed antenna system of the present invention. The system of FIG. 7 may be conventional in nature and may follow industry standard protocols. Currently, two industry standards groups exist (CPRI & OBSAI) that define such data link standards. These standard data links require each BTS to include a carrier precursor and TXIRX control multiplexer (700). The TX/RX control data within each standard includes custom control and configuration protocols based on the unique transceiver design of each manufacturer.

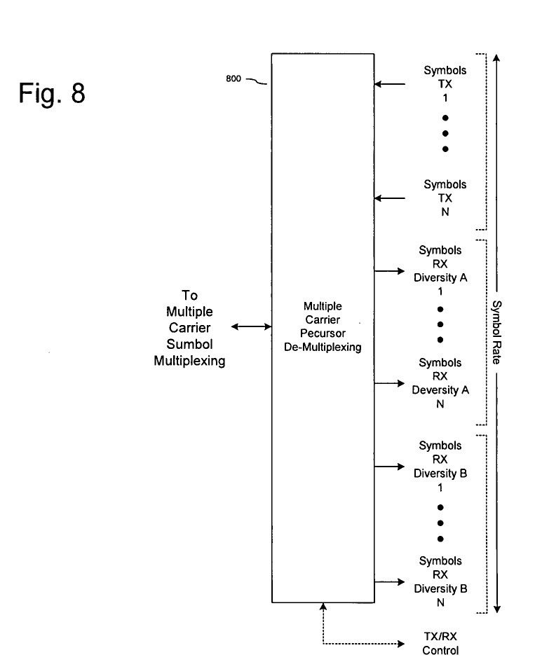

FIG. 8 shows a preferred embodiment of a multiple carrier precursor de-multiplexer (800) in accordance with another aspect of the present invention. Multiple carrier precursor de-multiplexer (800) forms part of the distributed antenna system of the present invention (as illustrated in FIG. 9 discussed below). This circuit block de-multiplexes the carrier precursor data back into individual carrier precursor data links. TX/RX control data is also de-multiplexed and pre-conditioned. As mentioned above in relation to FIG. 7, the BTS TX/RX control from the BTS includes custom control and configuration protocols based on the unique transceiver design of each manufacturer. Multiple carrier precursor de-multiplexer (800) responds to the BTS on these custom protocols and from these protocols determines new commands based on the following elements of the present invention.

In spread spectrum systems the multiple carrier precursor de-multiplexer and TX/RX control conditioner (FIG. 8, 800) may further process the de-multiplexed carrier information into earlier carrier precursors. For example in CPRI, chip data in sent on the BTS to transceiver link. This chip data may be divided and de-spread into individual user precursor symbols. The purpose of these additional steps would be to reduce the overall data transport rate of the final system data link (FIG. 9, 970) solution.

FIG. 9 shows a high level block diagram of the distributed antenna system of the present invention. The system includes a BTS “hotel” (900). This BTS hotel (900) may include several BTS (1 to M) (940, 945, 950). Different methods may be used by each BTS to create and receive TX/RX carrier information and TX/RX control information; for example, as described above in relation to FIGS. 14 and 7 (100/200, 300/400, 700). FIG. 9 shows two RX and one TX connections between BTS 1 (940) and BTS m (945) and a suitable signal conditioning block (955). The two RX connections shown represent two independent diversity receive paths used in one sector of a typical base station. The one TX connection shown represents the single multiple carrier transmit path used in one sector of a typical base station. For simplicity purposes, only one sector is shown. Those skilled in the art will appreciate the that these connections represent a typical base station and that some base station sectors have more than one TX path and others only use one RX path. BTS M (950) shows the data connection normally used to connect to a digital radio transceiver (FIG. 7, 775) connected to signal conditioning block (955). Those skilled in the art will appreciate that this represents a single sector connection and that more sectors may be connected in an actual system. The TX/RX carrier and control information from each BTS is connected to a signal conditioning system (955). Within the signal conditioning system, each BTS interface is pre-processed (500/600, 500/600, 800) prior to network interface formatting (960). Pre-processing (500/600, 500/600, 800) converts BTS compatible ports into TX/RX carrier precursors and conditioned TX/RX control. The TX/RX control is bi-directionally conditioned. By conditioning the TX/RX bi-directional control and equipment status data, signaling requirements of each originating BTS and terminating software defined radio can be satisfied. FIG. 9 shows two RX and one TX connection between the pre-processing blocks 500/600, 500/600, 800) and the network interface formatting block (960). The two RX connections represent two independent receive diversity paths. Each of these paths carry the individual carrier precursors shown in FIG. 6.

The one TX connection represents a data connection carrying the multiple carrier cursors shown in FIG. 5. The network interface formatting block (960) multiplexes the bidirectional data from each base station, both TX/RX carrier precursors and TX/RX control data, onto one link. This data link can then be distributed to several software defined radios using standard data network methods known to those skilled in the art.

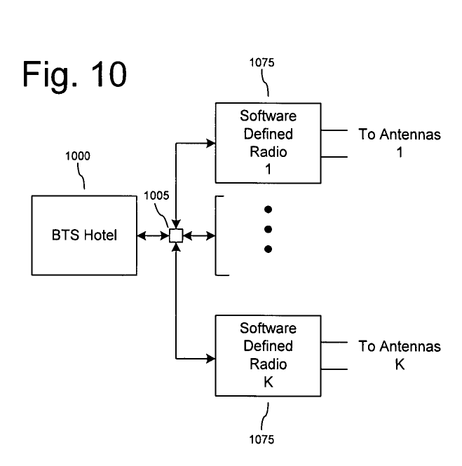

FIG. 10 shows one embodiment of a system network architecture with a BTS hotel (900) connected to several software defined radios (975) using a standard data network hub (1005). Several different methods exist for creating data network hubs. All of these methods are known to those skilled in the art.

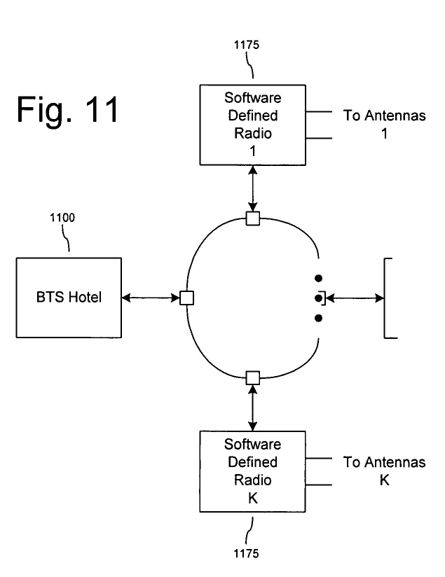

FIG. 11 shows another embodiment of a system network architecture with a BTS hotel (900) connected to several software defined radios (975) using a standard data network ring. Several different methods exist for creating data network rings. All of these methods are known to those skilled in the art.

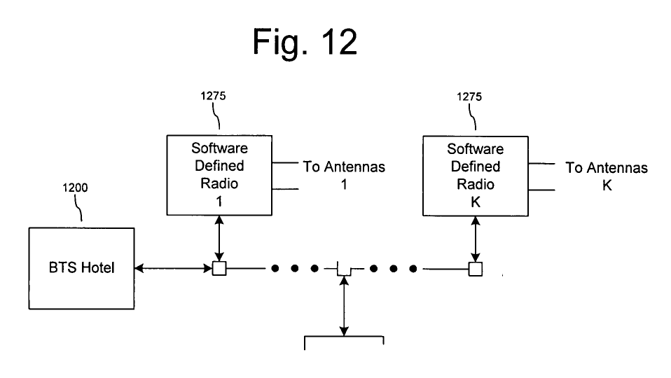

FIG. 12 shows another embodiment of a system network architecture with a BTS hotel (900) connected to several software defined radios (975) using a standard data network daisy chain. Several different methods exist for creating data network daisy chains. All of these methods are known to those skilled in the art.

In view of the foregoing it will be appreciated that the present invention provides a number of features and advantages. One benefit of the present invention is that time division multiplexed carrier precursors are communicated over the data network (970) regardless of the data network type used (FIG. 10, 11 or 12). By communicating carrier precursors, the transmission data rate is minimized. If the precursors transmitted are the gain weighted symbols used to create each carrier, remaining carrier information is relatively static and can be communicated using TX/RX control commands. Minimizing transmission data rates holds data distribution costs down, making systems more affordable.

In view of the above it will be appreciated the present invention has a number of different aspects. Although specific embodiments have been described above it will be appreciated by those skilled in the art that these are purely illustrative in nature and a wide variety of modifications and implementations are possible within the scope of the present invention.

What is claimed is:

1. A method of communication of wireless transmission signals to remotely located transmit locations, comprising:
generating a plurality of digital carrier precursor symbols corresponding to multiple RF carriers;
generating a combined multi-carrier RF signal from the plurality of carrier precursor symbols;
reproducing the precursor symbols of each of the carrier signals from the combined multi-carrier RF signal employing an RF-to-data conversion to extract the original digital carrier precursor symbols; and
sending the reproduced digital carrier precursor symbols to one or more remote transmit locations.

2. The method of claim 1 wherein generating a combined multi-carrier RF signal comprises:
generating a plurality of RF carrier signals from separate digital carrier precursor symbols; and
combining the plurality of RF carrier signals to generate said combined multi-carrier RF signal.

3. The method of claim 1 wherein generating a combined multi-carrier RF signal comprises:
combining the plurality of digital carrier precursor symbols to generate a combined multi-carrier digital signal, and
converting the combined multi-carrier digital signal into a combined multi-carrier RF signal.

4. The method of claim 1 wherein each of said remote transmit locations comprises a software defined radio and one or more antennas coupled thereto.

5. The method of claim 1 wherein sending the reproduced digital carrier precursor symbols to one or more remote transmit locations comprises sending the digital carrier precursor symbols over a data network.

6. The method of claim 1 wherein reproducing the precursor symbols of each of the carrier signals from the combined multi-carrier RF signal comprises:
sampling the combined multi-carrier RF signal at a first RF sample rate to provide a digital signal at the first RF sample rate;
converting the RF sample rate digital signal into a plurality of separate digital carrier signals; and
extracting the original digital precursor symbols from each digital carrier signal at a lower symbol sample rate.

7. The method of claim 6 wherein converting the RF sample rate digital signal into a plurality of separate digital carrier signals comprises:
splitting the RF sample rate digital signal into a plurality of digital signal processing paths; and
isolating one receive carrier on each digital signal processing path through frequency translation.

8. The method of claim 7 wherein reproducing the precursor symbols of each of the carrier signals from the combined multi-carrier RF signal further comprises:
providing a filtering operation on each digital signal processing path.

9. The method of claim 8 wherein reproducing the precursor symbols of each of the carrier signals from the combined multi-carrier RF signal further comprises:
receiving transmit control information; and
employing said transmit control information to control one or more of said operations of frequency translation, filtering and extracting the original digital precursor symbols from each digital carrier signal at a lower symbol sample rate.

10. The method of claim 1 further comprising:
receiving digital carrier precursor symbols from the remote transmit locations;
generating a plurality of carrier signals from the carrier precursor symbols; and
combining the plurality of carrier signals to generate a combined multi-carrier RF signal.

11. A wireless communication system for wireless transmission of signals to remotely located transmit locations, comprising:
a transmit base station that generates a combined multi-carrier RF signal from a plurality of digital carrier precursor symbols corresponding to multiple RF carriers; and
a precursor reproducer that reproduces the precursor symbols of each of the carrier signals from the combined multi-carrier RF signal, for transmission to one or more remote transmit locations.

12. The system of claim 11 wherein the transmit base station comprises:
a plurality of parallel signal generation paths that generate a plurality of RF carrier signals from separate digital carrier precursor symbols; and
a combiner that combines the plurality of RF carrier signals to generate said combined multi-carrier RF signal.

13. The system of claim 11 wherein the transmit base station comprises:
a plurality of parallel signal generation paths that generate a plurality of digital carrier precursor symbols;
a combiner that combines the plurality of digital carrier precursor symbols to generate the combined multi-carrier digital signal, and
a data-to-RF converter that converts the combined multi-carrier digital signal into a combined multi-carrier RF signal.

14. The system of claim 11 wherein each of said remote transmit locations comprises a software defined radio and one or more antennas coupled thereto.

15. The system of claim 11 further comprising a transmit module that transmits the reproduced digital carrier precursor symbols to one or more remote transmit locations over a data network.

16. The system of claim 11 wherein the precursor reproducer further comprises:
a sampler that samples the combined multi-carrier RF signal at a first RF sample rate to provide a digital signal at the first RF sample rate;
a converter that splits the RF sample rate digital signal into a plurality of separate digital carrier signals; and
a symbol extractor that extracts the original digital precursor symbols from each digital carrier signal by sampling each digital carrier signal at a lower symbol sample rate than the first RF sample rate.

17. The system of claim 16 wherein the converter comprises:
a splitter that splits the RF sample rate digital signal into a plurality of digital signals; and
a plurality of digital signal processing paths that receive that plurality of digital signals, wherein each digital signal processing path comprises a frequency translator that isolates one receive carrier signal from the respective digital signal.

18. The system of claim 17 wherein each digital signal processing path further comprises a baseband filter that provides a filtering operation on the receive carrier signal isolated by the corresponding frequency translator.

19. The system of claim 18 further comprising:
a control data link for receiving transmit control information;
wherein at least one of the frequency translators is responsive to the transmit control information for controlling the carrier signal isolation function of that frequency translator.

20. The system of claim 18 further comprising:
a control data link for receiving transmit control information;
wherein at least one of the baseband filters is responsive to the transmit control information for controlling the filtering operation of that baseband filter.

21. The system of claim 18 further comprising:
a control data link for receiving transmit control information;
wherein the symbol extractor is responsive to the transmit control information for controlling the operation of the symbol extractor in extracting the original digital precursor symbols from each digital carrier signal at said lower symbol sample rate.

22. A wireless communication system, comprising:
a base station that generates a combined multi-carrier RF signal from a plurality of digital carrier precursor symbols corresponding to multiple RF carriers;
a precursor reproducer that reproduces the precursor symbols of each of the carrier signals from the combined multi-carrier RF signal, for transmission to one or more remote transmit locations; and
a multiplexer that receives digital carrier precursor symbols from the one or more remote transmit locations, and generates a combined multi-carrier RF signal from the carrier precursor symbols for transmission to the base station.

23. The system of claim 22 wherein the multiplexer comprises:
a plurality of digital signal processing paths that receive separate digital carrier precursor symbols, wherein each digital signal processing path generates a carrier signal from corresponding digital carrier precursor symbols; and
a combiner that combines the plurality of carrier signals to generate said combined multi-carrier RF signal, for transmission to the base station.

24. The system of claim 22 further comprising:
multiple base stations, wherein each base station generates a combined multi-carrier RF signal from a plurality of digital carrier precursor symbols corresponding to multiple RF carriers;
multiple precursor reproducers, wherein each precursor reproducer reproduces the precursor symbols of each of the carrier signals from a corresponding combined multi-carrier RF signal, for transmission to one or more remote transmit locations; and
multiple multiplexers that receive separate digital carrier precursor symbols from one or more remote transmit locations, wherein each multiplexer generates a combined multi-carrier RF signal from corresponding carrier precursor symbols.

25. The system of claim 24, wherein each multiplexer includes:
a plurality of digital signal processing paths that receive separate digital carrier precursor symbols, wherein each digital signal processing path generates a carrier signal from corresponding carrier precursor symbols; and
a combiner that combines the plurality of carrier signals to generate a combined multi-carrier RF signal;
whereby multiple combined multi-carrier RF signals are generated for transmission to the multiple base stations.
